(19) United States
(12) Patent Application Publication
(10) Pub. No.: US 2004/0245795 A1
(43) Pub. Date: Dec. 9, 2004

(54) Cargo bed extension

(76) Inventor: William John Hansen, Holmen, WI (US)

Correspondence Address: M. PAUL HENDRICKSON, 403 MAIN STREET, P.O. BOX 508, HOLMEN, WI, 54636-0508, US

(21) Appl. No.: 10/860,764

(22) Filed: Jun. 3, 2004

Related U.S. Application Data
(60) Provisional application No. 60/476,775, filed on Jun. 5, 2003.

(51) Int. Cl. B62C 1/06

(52) U.S. Cl. 296/26.08

(57) ABSTRACT

There is provided a detachable cargo bed extender which when carried by a vehicle receiving hitch extends the cargo bed. The extender includes a supportive frame and a cross bar which may be adjusted upwardly and downwardly to a desired bed height, as well as, inwardly and outwardly to the desired bed width. Running lights provide safe vehicular operation of the attached cargo bed extender.

This application is a non-provisional application of earlier filed provisional application No. 60/476,775 entitled “Cargo Bed Extension”, filed on behalf of William John Hansen on Jun. 5, 2004.

### FIELD OF THE INVENTION

The present invention relates to a transport and more particularly to a vehicular cargo bed extender which may be inserted into a trailer hitch receiver of a vehicle to extend its cargo bed.

### BACKGROUND OF THE INVENTION

Many operators of vehicles are frequently faced with the perplexing problem of how to haul or transport an item to large or long for the vehicle bed. Many vehicles, such as the common car, simply have a trunk in which to transport items but this affords limited space for the transport of items of any bulk or size. Similarly, station wagons, SUVs, and cargo vans equipped with tail end cargo doors or end gates afford limited cargo space for hauling bulky items. By the same token, conventional pick-up trucks are likewise limited by the size of the cargo bed and often, it is necessary to utilize or hire a larger truck or trailer to transport larger items. Because of limited cargo room, these vehicles are often equipped with a trailer hitch, thus allowing the vehicle to transport larger and bulkier cargo. Vehicles are now commonly fitted with a rectangular tubular hitch receiver for mating onto a mating solid hitch adapter commonly referred to as a “ball mount”. When secured to the hitch receiver, the ball mount is fitted with a ball which allows the trailer ball receiver to be hitched to the vehicle.

Within recent years, there has been hitch adapters or accessories equipped to transport bicycles, motorcycles, small cargo platforms, etc. These hitch accessories are designed to secure and be carried by the hitch receiver, they typically are small in size, protruding rearwardly two feet or less, and normally constitute nothing more than a small platform, bin or hanger for whatever item is to be transported.

Numerous patents have disclosed various variations in expanding the cargo capacity of a vehicle. For example, U.S. Pat. No. 6,435,588 to Bauer discloses a truck bed extension which is releasably attached to a typical pickup truck bed to extend onto the tail gate. U.S. Pat. No. 6,422,627 to Kuhn discloses an apparatus for extending storage areas of vehicles which installs on a pickup truck tailgate and is folded and unfolded as desired. Another bed extender is disclosed in U.S. Pat. No. 6,378,926B1 to Renze, which discloses a lightweight and foldable truck bed extension apparatus posed on an open tail gate. In U.S. Pat. No. 6,425,618 to Garland there is also disclosed a support mechanism for a vehicle cargo bed equipped with bracket members for attachment to opposite side walls of the cargo bed and a support device with two end portions. U.S. Pat. No. 5,465,883 to Woodard discloses a windshield carrier rack mountable onto the hitch receiver of a pick-up truck. A cargo rack having plural predetermined attachment points for the support assemblies mounting onto the roof of the vehicle is disclosed in U.S. Pat. No. 5,829,654 to Weger, Jr. Another rack system for carrying bicycles and other items is disclosed in U.S. Pat. No. 6,164,508 to van Veenen in which a rack assembly mounted to a vehicle hitch receiver. The van Veenen rack is equipped with an inner swing arm having a first end mounted to a base member and an outer swing arm having a first end pivotally mounted to a second end of the inner swing arm and a rack member pivotally mounted to a second end of the outer swing arm, and locking means for selectively locking the base and rack members together to secure the system in a storage position. U.S. Pat. No. 6,019,265 to Deloza discloses a snowboard rack for transporting a snowboard with a pickup truck bed.

With the advent of large home improvement centers and ever increasing demand by consumers and contractors to transport goods often too bulkily for transport within any vehicle bed, there exists a need for an easy, inexpensive, and convenient device which would serve to extend the cargo bed. This would permit bulky items such as paneling, lumber, posts, etc, to be transported in a vehicle which normally would not have adequate cargo beds for such transportation. A cargo bed extender which could be simply installed when needed to provide the desired size so as to accommodate any given load size would allow consumers and contractors more versatility to utilized such existing vehicles to transport loads to large for the cargo bed. This would alleviate the more costly hiring of haulers and truckers to transport the goods for the home owner, contractors and others by offering a convenient and stowable device to transport bulky goods.

### SUMMARY OF THE INVENTION

Pursuant to the present invention, there is provided a vehicular bed extender adapted for securing onto a common vehicular hitch receiver so as to provide an extended cargo bed for a transporting vehicle. The extender includes:

a) a support beam equipped with multiplanar surfaced shank for mating and securance onto the vehicle hitch receiver so that upon securance within the hitch receiver will maintain the support beam in a fixed rearwardly extending position and

b) an adjustable cross bar supported by the support beam and equipped with an adjusting member so as to permit the cross bar to be vertically adjusted to the appropriate vertical positioning for transporting cargo thereupon.

The common set-up for connecting conventional ball mount to the hitch receiver may be used to connect the cargo bed extender of this invention to the hitch receiver. The proximate end of the support beam may be constructed to match the configuration of the ball mount for the vehicle hitch. Accordingly, the proximate end the support beam may comprise a solid or tubular square with one or more pinning apertures for alignment and pinning onto the hitch receiver pin bore. The vehicular bed extension construction may comprise a frame equipped with a square hitch receiving assessory equipped with a lynch pin receiving hole adapted to engage onto a standard hitch receptor.

The other end (i.e. distal end) of the support beam or frame may be equipped with a vertical post mount for mounting an adjustable support bar to the frame. The cross bar is supported by a vertically disposed support post which can be adjusted upwardly or downwardly as desired. When it is desired to haul bulky and lengthy cargo with the cargo bed extender of this invention, the cargo bed extender is merely inserted and secured onto the vehicular hitch receiver. The gate of the vehicle is then opened and the support post supportive of the adjustable cross bar is adjusted to the desired vertical positioning in relation to the cargo bed of the vehicle. The cross bar may also be conveniently equipped to adjust to the desired load width. Once this is accomplished, the cargo may be merely placed upon the vehicle bed and the cross bar of the extender and transported to the desired location. Upon completion of the transport, the cross-bar and extender may be disassembled and stowed for future use. By equipping the cargo bed with running lights operatively connected to the operational lighting system of the transporting vehicle, the cargo bed extender can be placed in conformance with most Department of Transportation regulations. If desired, the support beam may also be equipped so that it may longitudinally adjusted so as to provide a support bed adjustable to a desired beam length for the use of various length cargoes transported thereupon.

### BRIEF DESCRIPTION OF THE DRAWINGS

FIG. 1 is a side view depicting a part a rear bed section of a conventional pickup truck equipped with the vehicular bed extender of this invention.

FIG. 2 is an opposite side view of a support beam of the vehicular extender depicted in FIG. 1 extending outwardly from a vehicular hitch of the pick-up truck.

FIG. 3 is a rear view of cross bars shown in FIG. 1 and equipped with running lights and adjusting bars so as to allow the bed extender to allow lateral extension of the bed extender

FIG. 4 is a side view of cross bar support post shown in FIG. 1 adapted to adjust upwardly or downwardly to accommodate an appropriate bed height

FIG. 5 is an opposite side view of the lighting fixture shown in FIG. 1.

FIG. 6 is a frontal view of the support post shown in FIG. 4.

FIG. 7 is a side view of the support beam equipped with a cross bar support mount.

FIG. 8 is a rear view of cross bar, post support mount and lighting system of the extender shown in FIG. 1.

FIG. 9 is a partial side view of the distal end of the extender shown in FIG. 1.

FIG. 10 is an elevational side view of the extender of this invention carried by the transporting vehicle with a cargo end gate lowered and the cross bar adjusted to vertically match the cargo bed height.

FIG. 11 is a side view of the extender shown in FIG. 1 which has been modified to include a telescoping frame.

### DETAILED DESCRIPTION OF THE INVENTION

Pursuant to the present invention, there is provided a vehicular cargo bed extender 1 adapted for insertion into a multiplanar vehicular hitch receiver R so as to provide an extended cargo bed B for a transporting vehicle V, said extender 1 comprising:

a) a support beam 3 having a multiplanar surfaced shank 5 matingly insertable into the multiplanar vehicular hitch receiver R and which upon insertion within the receiver R maintains the support beam 3 in a fixed rearwardly extending position, and

b) an adjustable cross bar 7 carried by the support beam 3 and equipped with graduated post support mount 19 so as to permit the cross bar 7 to be vertically adjusted to an appropriate vertical positioning for transporting cargo C thereupon.

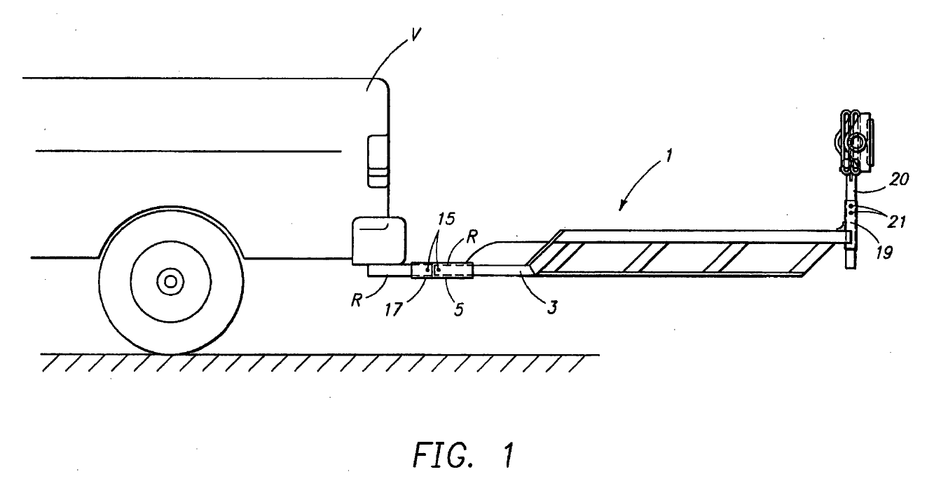

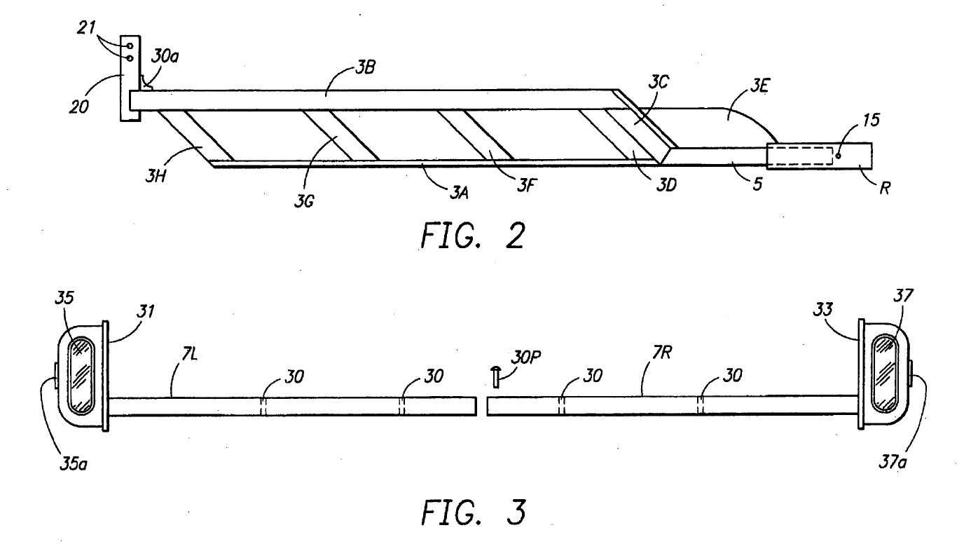

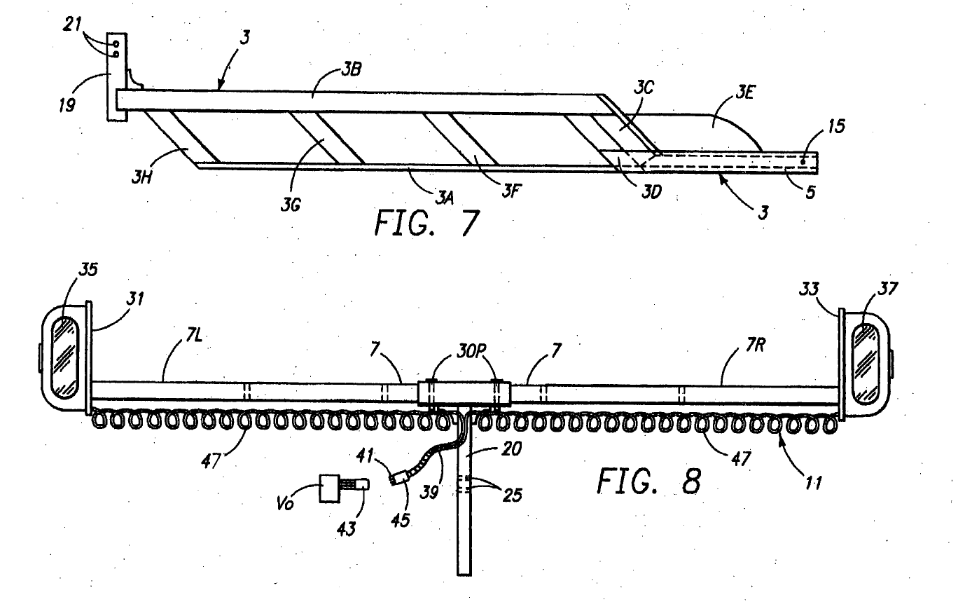

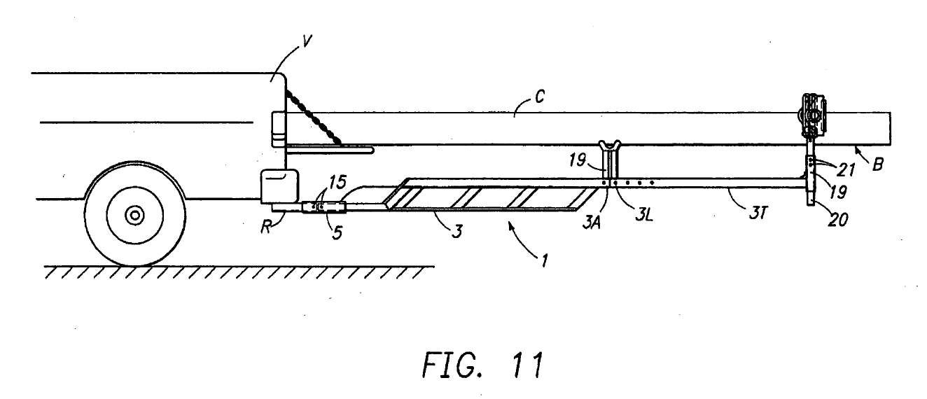

The cross bar 7 may also be equipped so that it may be adjusted inwardly and outwardly from the support beam 3 to accommodate a desired cargo bed width. The cargo bed extender 1 is also advantageously equipped with running light circuitry 11 for interconnection to an operational lighting system for the transporting vehicle V. The proximate end of the cargo bed extender 1 is suitably equipped with multiplanar surfaced shank 5 of a polygonal configuration for insertion and mounting onto a mating vehicular tubular hitch receiver R. Shank 5 is suitably of the same size and shape of ball mounts for the hitch receiver R of the transporting vehicle V. Shank 5 is most typically of a rectangular or square shape so as to mate onto the most common rectangular shaped vehicle receiver R of modern vehicles. By constructing the support beam 3 of square O.D. tubular construction to mate onto the hitch receiver R, the support beam 3 my be utilized to serve a dual purpose. The squared shaped hitch adapter or shank 5 may be provided with one or more pin receiving apertures 15 as illustrated in FIGS. 1, 2, 7, 10 and 11 which allow the inserted hitch mount 5 to be pinned with a securing pin 17 to the hitch receiver R. The multiple pin receiving aperture 15 affords a limited ability to adjust the bed length. If desired, the support beam 3 may be appropriately equipped with a longitudinal adjusting support beam 3 such as a telescoping inner beam 3T and outer beam 3B open ended to received telescoping inner beam 3T as depicted in FIG. 11 so as to permit the support beam 3 to be adjusted to a desired beam length for use in the transport of cargo C thereupon. The adjustable support beam 3 may include an outer tubular support beam 3B and an inner telescoping beam 3T disposed therewithin and a latching unit 3L for latching the inner telescoping beam 3T at the desired beam length.

The cross bar 7 is advantageously constructed so as to permit both vertical and lateral positioning relative to the major longitudinal axis of the support beam 3. Vertical cross bar 7 positioning may be effectively accomplished by equipping a rear margin or distal end of support beam 3 with cross bar post mount 19 welded or secured to the support beam 3. Cross bar post mount 19 is appropriately fitted with a graduated stop 21 shown a series of stops 21 for adjustably sliding the cross bar post support 20 to the desired vertical bed height. A graduated post support 20 also having a series of latching stop apertures 25 for pinning to stops 21 allow for vertical adjustment of the adjustable support post 20.

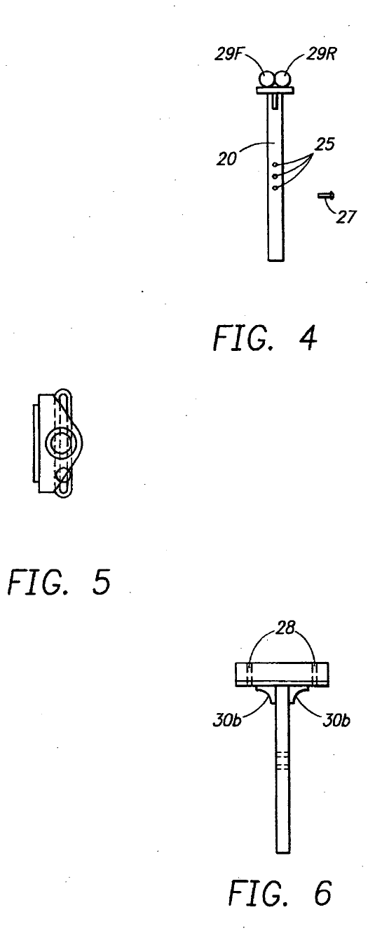

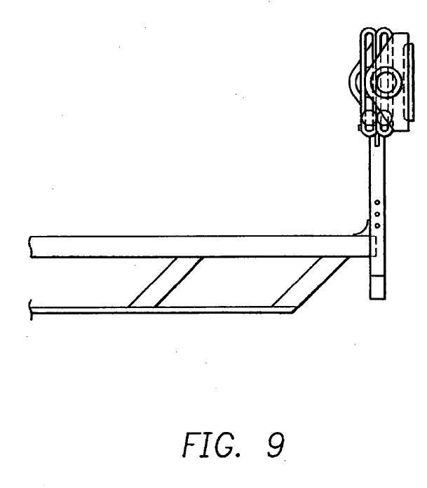

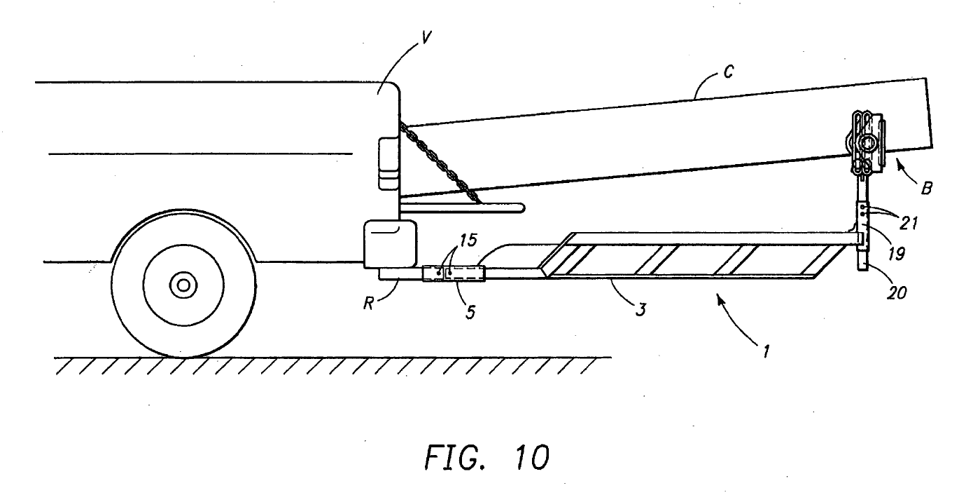

The post mount 19 may be conveniently constructed of a pipe open at both ends for snugly accommodating the pipe shaped support post 20. As may be observed in part by FIGS. 4 and 9, both the cross bar support post 20 and the cross bar post mount 19 are equipped with a plurality of latching pin apertures 21 & 25 which allows the cross bar support post 20 to be adjusted to the appropriate height by mating the latching pin apertures 21 & 25 at the desired height and then inserting a latching pin 27 at the desired vertical positioning.

The cross bar 7 may be provided as two separate cross bars (7L & 7R) which may be laterally adjusted to the appropriate bed width. It will be observed in particular by FIGS. 4, 5 and 10 that the cross bar support post 20 includes a pair of laterally disposed channeled cross bar support guides (front and rear) 29F & 29R which serve to receive and maintain the left cross bar 7L and the right cross bar 7R (shown separately in FIG. 3) at a desired cross bar transporting positioning or width as illustrated by the view of FIG. 8.

Both the front support guide 29F and the rear support guides 29R are equipped with guide stops 28 which when mated onto corresponding lateral stops 30 and pinned with cross bar pins 30P maintain cross bars 7L & 7R at the desired lateral distance from support beam 3. Both cross bars 7L & 7R are equipped with a plurality of lateral stops 30 which provide lateral adjusting means for adjusting the cross bars 7L & 7R to the appropriate bed width. Other locking means (not shown) such as clamps, biasing or tightening nuts or envelopes, friction locks, telescoping cross bars etc may be utilized for this purpose.

The terminating outer ends of the left cross bar 7L and the right cross bar 7R are respectively equipped with a vertical left side rail 31 and a right side rail 33 which serve as guide rails for preventing the load C from sliding sideways or otherwise being dislodged from the transportation carrier.

As may be observed form the Figures, the extender 1 extends the bed capacity of the transporting vehicle V beyond its rear running lights. It is therefore desirable to equip the extender 1 with extender tail lights 35 & 37 operatively connected to the vehicular running lights. This provides the required directional turn, brake, back-up, and running lights for day time and night time operation of the vehicle equipped with the extender. Placing the extender tail lights 35 & 37 outside side rail 31 and side rail 33 protects the lights 35 & 37 from damage. Conventional trailers lights equipped with directional, back-up, stop, flashing, and night time running capabilities operationally connected via the customary pigtail linkages to the vehicle trailer lights system may be used for this purpose. Since it is desirable for the cross bar 7 with lights 35 & 37 be detachable, a three linkage circuitry system 11 is preferred. As depicted in FIG. 8, a four wire main line 39 equipped with a male prong 41 at one end for hooking to the vehicular outlet plug Vo and a split four line terminating with a female socket plugs 43 at the terminal end of main line which when connected to a male prong 45 serves to distribute electricity to the brake and tail lights 35 & 37 and the running lights 35a & 37a through coiled lateral lines 47, all of which serves to carry the electricity from the power outlet Vo to lights 35, 37, 35a & 37a.

Coiled electrical conduits 47 (such as shown in part in FIG. 8) which uncoil when stretched and recoil when relaxed are particularly will suited for adjustable cross bars 7L & 7R. Such coiled electrical conduits allow cross bars 7L and 7R to be drawn outwardly from support beam 3 or placed inwardly while still maintaining the electrical conduit 47 sufficiently taunt to prevent snagging.

The hitch adapter 5 is sized so as to mate onto conventional hitch receivers R which most typically range in sized from one, 1½, to 2 inch squares. Class III hitch receivers R adapted to receive a two inch square ball mount adapter are preferred. The heavier gauge tubular stock (¼″ thick) and two inch square tubing contributes adequate strength to that portion of the support beam 3 bearing the load.

The depicted support beam 3 includes a lower beam section 3A terminating at the proximate end with the hitch adapter 5 section. The lower support beam section 3A may be sized so as to snugly house within the hitch receiver R and is stepped upwardly at an incline to an upper support beam 3B by a pair of 1 1/2 inch (11 gauge) tubular square struts 3C & 3D welded onto the upper support beam 3B and at an incline to the lower support beam 3A. The bottom of the support beam 3 is braced by a bottom brace 3E of a 1½″×1/4″ flat stock steel welded to bottom support beam 3A and extending laterally in a parallel relationship and towards the distal end of the upper support beam 3B. Struts 3F, 3G, and 3H of the 1½″, 11 gauge square tubing bridging between the upper support beam 3B and the bottom beam 3A welded diagonally together to provide added structural strength to the bed extender 1.

The support post 20 may comprise a 1½″ O.D., 0.095″ thick steel pipe welded at the distal end of the top beam 3B. Bottom brace 3E serves as a reinforcement plate welded to the lower beam section 3A and struts 3C & 3D which reinforces the support beam 3 so as to allow it to bear heavy loads. A welded corner brace 30a reinforces the support post 20.

The support post 20 serves as a mounting post for two six inch in length 1½″ O.D., 0.095 inch thick pipes welded in a T and perpendicular relationship to the support post 20, which pipes serve as the front and rear cross bar support guides 29F & 29R. Corner bracing plates 30b inpart added supportive strength to support guides 29F & 29R.

The support post 20 and the left and right cross bars 7L & 7R are constructed of 1.25″ O.D., 0.95″ wall steel pipe which house snugly in the post mount 19 and the cross bar support guides 29F & 29R. The pin receiving apertures 15, 21, 25 and 30 are all drilled to 5/16″ bore so as to engage a 5/16″ latching pin.

What is claimed is:

1. A vehicular cargo bed extender adapted for insertion into a multiplanar vehicular hitch receiver so as to provide an extended cargo bed for a transporting vehicle, said extender comprising:
a) a support beam having a multiplanar surfaced shank insertable into the multiplanar vehicular hitch receiver which upon insertion within the receiver maintains the support beam in a fixed extending position, and
b) an adjustable cross bar supported by the support beam and equipped with an adjusting member so as to permit the cross bar to be vertically adjusted to an appropriate vertical positioning for transporting cargo thereupon.

2. The cargo bed extender according to claim 1 wherein the cross bar in relation to the support beam may be adjusted inwardly and outwardly so as to accommodate a desired cargo bed width.

3. The cargo bed extender according to claim 1 wherein the extender includes running lights for interconnection to an operational lighting system of the transporting vehicle.

4. The cargo bed extender according to claim 1 wherein the multiplanar surfaced hank comprises a polygonal shank for insertion into a mating vehicular tubular hitch receiver.

5. The cargo bed extender according to claim 2 wherein the shank is of a rectangular shape for mating onto a rectangular shaped vehicular receiver.

6. The extender according to claim 1 wherein the support beam is equipped with a longitudinal adjusting member so as to permit the support beam to be adjusted to a desired beam length for use in the transport of cargo thereupon.

7. The extender according to claim 6 wherein the support beam includes an outer tubular support beam and an inner telescoping beam disposed therewithin and a latching unit for latching the inner telescoping beam at the descried beam length.

8. The extender according to claim 2 wherein the cross bar comprises a telescoping cross bar for adjustment to the desired cargo bed width.

9. The extender according to claim 1 wherein the cross bar comprises a supportive post for supporting the cross bar upon said support beam and the adjusting member includes a supportive post housing for slideably engaging and latching the supportive post to the appropriate vertical positioning.

10. A method of extending a cargo bed of a vehicle equipped with a cargo bed, said method comprising:
a) providing a load extending unit comprised of a longitudinally extending support beam equipped with a vertically adjustable cross bar and a multiplanar shank for insertion into a shank receiver so as to maintain the support beam at a fixed longitudinal extending position, and
b) inserting the multiplanar shank into the fixed shank receiver of said vehicle,
c) adjusting the adjustable cross bar to a desired vertical position in relation to said cargo bed of said vehicle,
d) placing cargo upon the vehicular bed and the cross bar of said extender, and
e) transporting the cargo placed upon said cargo bed and said extender with said vehicle.

11. The method according to claim 10 wherein the adjustable cross bar may also be adjusted inwardly and outwardly so as to accommodate a desired cargo bed width and the method includes positioning the cross bar to the desired cargo bed width.

12. The method according to claim 10 wherein the shank includes a pin receiving aperture which mates onto a mating bore provided by the receiver and the method includes inserting the shank into the receiver and aligning the pin receiving aperture onto the mating bore, and securing the pin therewithin

13. The method according to claim 12 herein the extender is equipped with a detachable running light circuitry adapted for interconnection to an operational lighting system of a vehicle and the method includes interconnecting the detachable running light circuitry of the extension to the operational lighting system of the vehicle.

14. The method according to claim 11 wherein the method includes lowering an end gate of said vehicle before the adjusting of the adjustable cross bar.

15. The method according to claim 13 wherein the extension comprises detachable cross bars equipped with running lights attached thereto and the method comprises:
a) unloading the cargo from the cross bar.
b) disconnecting the running light circuitry from the operational lighting system of the vehicle,
c) detaching the cross bar from the support beam, and
d) removing the support beam from the vehicular hitch receiver.

16. In combination with a vehicle having a cargo bed for placement of cargo thereupon, an end gate for accessing to the cargo bed and a multiplane vehicular hitch receiver for receiving and supporting a mating shank insertable therewith and a cargo bed extender equipped with a longitudinally extending support beam fitted with the mating shank inserted within and supported by the hitch receiver, an adjustable cross bar supported by the support beam and equipped with an adjusting member so as to permit the cross bar to be vertically adjusted to an uppermost vertical position for transporting cargo thereupon.

17. The combination according to claim 16 wherein the vehicle includes an operational electrical system for operation of the vehicle and extender includes a running light circuitry operationally connected to the operational electrical system of the vehicle.

18. The combination according to claim 16 wherein the cross bar is detachably mounted to the support beam and the support bar is equipped for adjustment inwardly and outwardly so as to accommodate a desired cargo bed width.

19. The combination according to claim 18 wherein the hitch receiver includes a rectangular receiving channel having latching apertures therewithin and the shank comprises a mating rectangular shaped shank inserted within the receiving channel and pinned to the latching aperture with a latching pin.
